(19) United States
(12) Patent Application Publication
(10) Pub. No.: US 2008/0072195 A1
(43) Pub. Date: Mar. 20, 2008

(54) Validation processing apparatus

(75) Inventor: Akira MUKAIYAMA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 11/900,822

(22) Filed: Sep. 13, 2007

(30) Foreign Application Priority Data
Sep. 14, 2006 (JP) 2006-249419

(51) Int. Cl. G06F 17/50

(52) U.S. Cl. 716/5

(57) ABSTRACT

A validation processing apparatus is to be provided, which allows a user to easily check whether a request designated by the user is satisfied by a data processing system, which is the object to be validated, and to easily check a result of coverage measurement in the data processing system based on a coverage metrics designated by the user. The validation processing apparatus acquires a state transition graph of the data processing system, being the object to be validated; acquires the request to the data processing system; and acquires a coverage metrics indicating events to be included in the validation range of the data processing system. Then the validation processing apparatus validates whether the acquired state transition graph satisfies the request; measures the coverage in the state transition graph according to the acquired coverage metrics; and outputs a result.

This application is based on Japanese patent application No. 2006-249419, the content of which is incorporated hereinto by reference.

### BACKGROUND

1. Technical Field

The present invention relates to a validation processing apparatus to be used for validating whether a design of a data processing system satisfies the predetermined functional specification, and to a computer program for operating the validation processing apparatus.

2. Related Art

Methods of validating a data processing system such as a logic circuit or a computer program by model checking have conventionally been developed. The model checking is utilized for deciding whether a graph (state transition diagram) representing state transition relation of a finite state machine includes a state and a transition path that have a certain characteristic. Each state of the state transition diagram is associated with a proposition that is true under the state, and the “characteristic” to be decided by the model checking is defined by the temporal change of the proposition.

FIG. 3 shows an example of the state transition diagram. In FIG. 3, each ellipse represents a state, and arrows indicate the transitions among the states. Codes x, y, z each represent a proposition, and the x, y, z marked in the ellipse represent the proposition that is true under the state corresponding to the ellipse.

For example, under the states that can be reached via twice of transitions from the state 101, i.e. the states 102, 103, 104, 105, 106, y is true. Accordingly, the state 101 can be regarded as having a characteristic that “y remains true (irrespective of which type of transition takes place) over the subsequent two steps”.

Likewise, the path that follows the transitions through the states 107, 108, 109, 110, 111, 112 can be regarded as having a characteristic that “such pattern that x is followed by y is consecutively repeated three times”.

In the model checking, all the states and paths of the state transition diagram (state transition graph) are examined, to thereby decide whether a state and a transition path having the designated characteristic are present. The validation processing apparatus utilizing the model checking converts the event that takes place in the data processing system, which is the object to be validated, into the state transition diagram, and the functional specification of the data processing system being the object to be validated, into the characteristic of the state or the transition path included in the state transition diagram.

Thus, deciding through the model checking whether the state or the transition path designating the functional specification is present leads to validating whether the data processing system satisfies the functional specification. In the validation processing apparatus utilizing the model checking, a restrictive condition is often given to thereby restrict the validation range on the state transition diagram, for executing the validation quicker.

For example, when a restrictive condition that “x, y, z cannot be true at the same time” is given in the diagram of FIG. 3, the portion indicated by the reference numeral 112 in FIG. 4 is excluded, so that the validation is executed only in the remaining portions. This is because the state 108 represents a state that x, y, z are true at the same time, which is contradictory to the restrictive condition.

Methods of executing the model checking so far developed include executing the inspection exclusively through a logic function process, without expressly composing the state transition diagram. Currently, proposals of the validation processing apparatus based on such method can be found, for example, in JP-A No. H10-63537, JP-A No. 2001-318959, and in the non-patented document 1 cited here below.

[Patented document 1] JP-A No. H10-63537

[Patented document 2] JP-A No. 2001-318959

[Non-patented document 1] Hiraishi, Hamaguchi, et al., “Formal validation method based on logic function process” in “Joho Shori” published by IPSJ, Vol. 35(8), pp. 710-718

The conventional validation processing apparatus, however, merely provides the user with information as to whether the state or transition path designating the functional specification of the object to be validated, i.e. the data processing system, is present in the portion of the state transition diagram where the validation has been performed.

In other words, the conventional validation processing apparatus provides no alert of an error to the user, for example in case where the user applies, by misunderstanding or the like, an improper restrictive condition that should not be given to the conventional validation processing apparatus, which may lead to exclusion of those states that should normally be validated, from the validation range of the state transition diagram.

### SUMMARY

In one embodiment, there is provided a validation processing apparatus comprising a graph acquisition unit that acquires a state transition diagram of a data processing system being an object to be validated; a property acquisition unit that acquires a request to the data processing system; an index acquisition unit that acquires a coverage metrics indicating an event to be included in a validation range of the data processing system; a property validation unit that validates whether the acquired state transition diagram satisfies the request; a validation output unit that outputs a validation result of the request; a coverage measurement unit that measures the coverage in the state transition diagram according to the acquired coverage metrics; and a measurement output unit that outputs a measurement result of the coverage.

The validation processing apparatus thus constructed validates whether the data processing system, which is the object to be validated, satisfies the request designated by a user, and outputs the result. The validation processing apparatus then measures the coverage in the data processing system being the object to be validated, according to the coverage metrics index designated by the user, and outputs the measurement result.

Here, it suffices that the constituents referred to in the present invention are made up so as to perform the respectively assigned function. For example, an exclusive hardware that performs a predetermined function, a validation processing apparatus carrying a predetermined function granted by a computer program, a predetermined function materialized in the validation processing apparatus via the computer program, and a desired combination thereof may be employed.

Also, it is not mandatory that the constituents of the present invention are individually independent from others, and a plurality of constituents may be integrated into a component; a constituent may be constituted of a plurality of components; one of the constituents may be a part of another constituent; and a part of one of the constituents may be utilized in common as a part of another constituent.

Further, the term “to be input” according to the present invention encompasses accepting data, for example via keyboard manipulation by a user, receiving data transmitted via wire or wireless communication, reading out stored data such as a memory, and the like.

The validation processing apparatus according to the present invention allows the user to check the validation result on whether the data processing system, which is the object to be validated, satisfies the request designated by the user. The validation processing apparatus further allows the user to check the measurement result of the coverage in the data processing system being the object to be validated, according to the coverage metrics designated by the user.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a logical structure of a validation processing apparatus according to a first embodiment of the present invention;

FIG. 2 is a block diagram showing a logical structure of a validation processing apparatus according to a second embodiment of the present invention;

FIG. 3 is a schematic diagram showing a logical structure of a state transition diagram; and

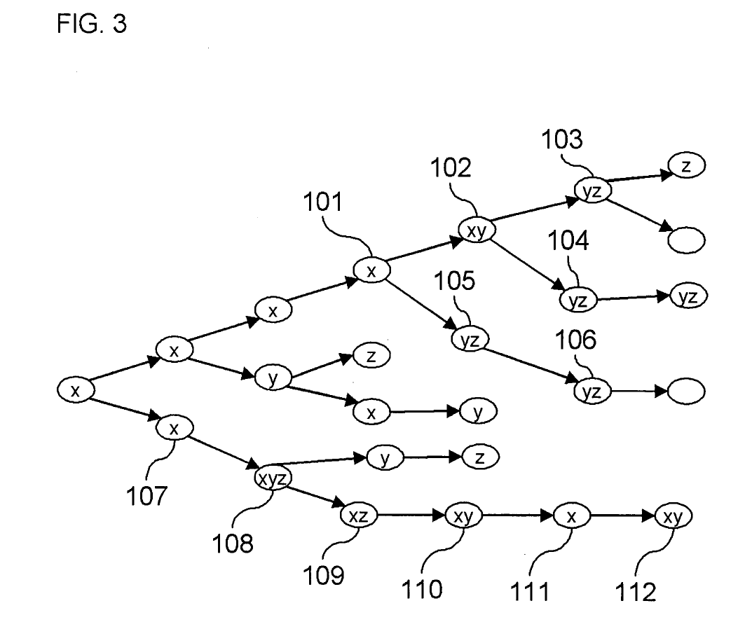

FIG. 4 is a schematic diagram showing the state transition diagram with a restrictive condition applied thereto.

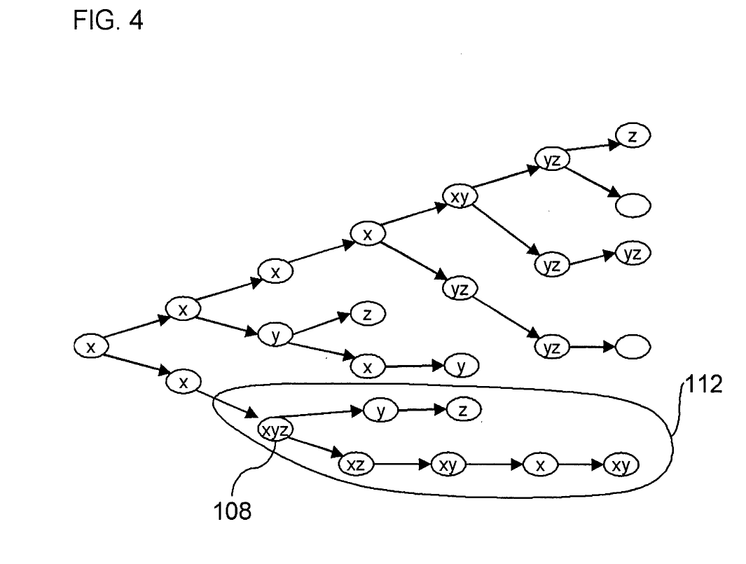

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

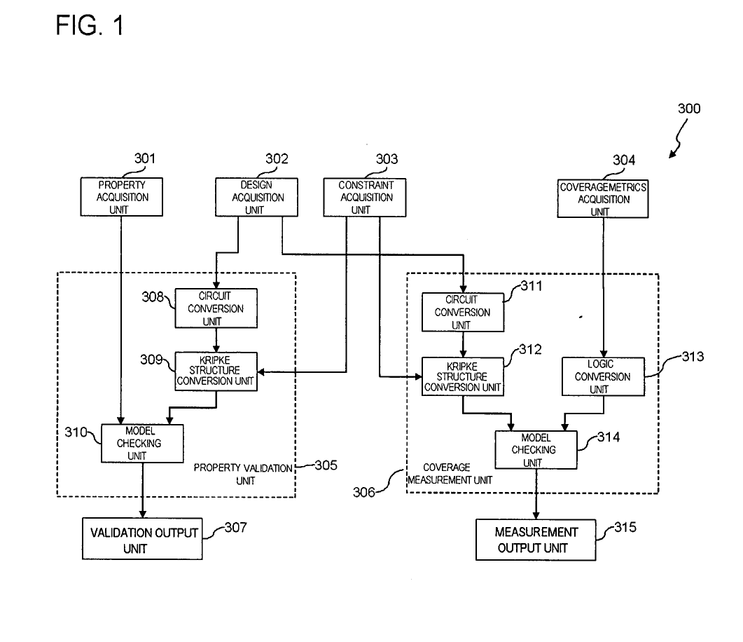

A first embodiment of the present invention will be described referring to FIG. 1. FIG. 1 is a block diagram showing a logical structure of a validation processing apparatus according to this embodiment.

The validation processing apparatus 300 according to this embodiment includes a graph acquisition(input) unit that acquires a state transition graph of a data processing system being an object to be validated, a property acquisition(input) unit 301 that acquires a request to the data processing system, an index acquisition (input) unit 304 that acquires a coverage metrics index indicating an event to be included in a validation range of the data processing system, a property validation unit 305 that validates whether the acquired state transition graph satisfies the request, a validation output unit 307 that outputs a validation result of the request, a coverage measurement unit 306 that measures the coverage in the state transition graph according to the acquired coverage metrics, and a measurement output unit 315 that outputs a measurement result of the coverage.

The validation processing apparatus 300 further includes a design acquisition(input) unit 302 that acquires design data describing at least one of the function and the specification of the data processing system, being the object to be validated, and a constraint acquisition(input) unit 303 that acquires a restrictive condition that delimits a validation range in the events of the data processing system.

The property validation unit 305 includes a circuit conversion unit 308 that converts the acquired design data into a Sequential circuit, a Kripke structure conversion unit 309 that converts the Sequential circuit into a state transition diagram according to the acquired restrictive condition, and a model checking unit 310 that validates through model checking whether the acquired state transition diagram satisfies the request.

The coverage measurement unit 306 includes a circuit conversion unit 311 that converts the acquired design data into a Sequential circuit, a Kripke structure conversion unit 312 that converts the Sequential circuit into a state transition diagram according to the acquired restrictive condition, a logic conversion unit 313 that converts the acquired coverage metrics into a temporal logic, and a model checking unit 314 that measures the coverage in the state transition diagram through the model checking, according to the converted temporal logic.

To be more detailed, the property acquisition unit 301 receives an input of the functional specification to be fulfilled by the data processing system as a request (property), in a form of a temporal logic such as a computation tree logic (hereinafter, CTL) or a linear temporal logic (hereinafter, LTL), or a property language such as a property specification language (PSL) or a system Verilog assertion (SVA).

The data processing system, being the object to be validated, may be a logic circuit or a computer program, for example. The request to such data processing system includes, for example, the function and specification that the data processing system is expected to fulfill.

The functional specification may be construed as a proposition on a value or a temporal change thereof of a signal or a variable in the logic circuit or the computer program, and examples of the propositions may include, “The value of the signal S and the signal T cannot be 1 at the same time”, “If the value of the signal U becomes 1, the value of the signal V becomes 1 within the subsequent three clocks”, and “The value of the variable A is always 10 or greater but less than 100”.

The design acquisition unit 302 receives an input of the structure and function of the data processing system, in a form of design data expressed by a logic circuit description language such as VHDL or Verilog, or a software program language such as the C language or Java (registered trademark).

The constraint acquisition unit 303 receives an input of the restrictive condition that delimits a validation range in the events of the data processing system, in a form of a logical formula or a temporal logic in which a variable used to describe the data processing system is incorporated.

The index acquisition unit 304 receives an input of the coverage metrics indicating the events to be included in the validation range of the data processing system. Here, the term “coverage metrics” herein means the scale by which the coverage is measured.

The terms “coverage” herein means, with respect to the validation of the logic circuit or computer program, the ratio of the events actually validated, out of all the events that may arise in the object to be validated. However, the concept of “all the events that may arise” is not subject to a universal definition, and actually an appropriate evaluation criterion is introduced according to the purpose of the validation.

Examples of employing the index may include focusing on rows of a software, to thereby measure the coverage based which rows, out of all the rows, are eligible for validation of the corresponding event, and focusing on signal values, so as to measure the coverage based on which values of a signal A, for example out of 100 values applicable thereto, are eligible for the validation.

In the case of the validation processing apparatus 300 according to this embodiment, a plurality of propositions on the value or temporal change thereof of the signal and the variable is defined in advance, so as to calculate the “coverage metrics” based on how many of the propositions, out of all those defined in advance, are included as true in the validation.

Such coverage metrics is designated by means of expressions such as whether an event originating from a row is included in the description of the data processing system; whether an event that a variable present in the description of the data processing system becomes equal to a predetermined value is included; whether an event that a logical formula including a variable present in the description of the data processing system is established is included; whether an event that the truth or falsehood of a logical formula including a variable present in the description of the data processing system indicates a predetermined permutation or a temporal change is included; or the like.

The property validation unit 305 executes the model checking based on the property acquired by the property acquisition unit 301, the design data of the data processing system acquired by the design acquisition unit 302, and the restrictive condition acquired by the constraint acquisition unit 303.

For this purpose, the circuit conversion unit 308 converts the design data of the data processing system acquired by the design acquisition unit 302 into a Sequential circuit. The Kripke structure conversion unit 309 converts the Sequential circuit converted by the circuit conversion unit 308 into the state transition diagram for the model checking called a “Kripke structure”, according to the restrictive condition acquired by the constraint acquisition unit 303.

The model checking unit 310 executes the model checking, over the Kripke structure converted by the Kripke structure conversion unit 309 and the property acquired by the property acquisition unit 301. The validation output unit 307 outputs the result on whether the property acquired by the property acquisition unit 301 is established, based on the result of the model checking executed by the model checking unit 310.

The coverage measurement unit 306 measures the coverage in the design data of the data processing system acquired by the design acquisition unit 302, in the validation range delimited by the restrictive condition acquired by the constraint acquisition unit 303, according to the coverage metrics acquired by the index acquisition unit 304.

For this purpose, the circuit conversion unit 311 converts the design data of the data processing system acquired by the design acquisition unit 302 into a Sequential circuit. The Kripke structure conversion unit 312 converts the Sequential circuit converted by the circuit conversion unit 311 into the state transition diagram having the Kripke structure, according to the restrictive condition acquired by the constraint acquisition unit 303.

The logic conversion unit 313 converts the coverage metrics acquired by the index acquisition unit 304 into a temporal logic such as the CTL or LTL. The model checking unit 314 measures, through the model checking, the coverage in the state transition diagram having the Kripke structure converted by the Kripke structure conversion unit 312, according to the temporal logic converted by the logic conversion unit 313. The measurement output unit 315 outputs the result of the coverage metrics acquired by the index acquisition unit 304, based on the result of the model checking executed by the model checking unit 314.

It is to be noted that in the validation processing apparatus 300 according to this embodiment, the path from the circuit conversion units 308, 311 to the Kripke structure conversion units 309, 312, through which the Sequential circuit is provided, corresponds to the circuit acquisition unit which acquires the Sequential circuit of the data processing system.

The path from the kripke structure conversion units 309, 312 to the model checking units 310, 314, through which the state transition diagram is provided, corresponds to the graph acquisition unit which acquires the state transition diagram of the data processing system.

The validation processing apparatus 300 according to this embodiment may be constituted of a so-called computer apparatus, in which a computer program is implemented. The computer program causes the hardware to perform the predetermined functions, to thereby logically materialize the respective functions via the foregoing units 301 to 315.

For example, the acquisition units 301 to 304 correspond to such computer functions as accepting, according to the computer program, various data input by the user via keyboard manipulation, and as reading out the data stored in a recording medium such as a compact disc-recordable (CD-R).

The output units 307, 315 correspond to such computer functions as outputting a display of various data on a display unit according to the computer program, and as storing various data in the CD-R or the like. The remaining units 308 to 310 and 311 to 314 correspond to the computer function of executing various data processing jobs according to the computer program.

The computer program that causes the foregoing units 301 to 315 to perform the respective functions in the validation processing apparatus 300 may be described, for example, so as to acquire the request to the data processing system, to acquire the design data of the data processing system, to acquire the restrictive condition of the data processing system, to acquire the coverage metrics of the data processing system, to convert the acquired design data into the Sequential circuit, to convert the Sequential circuit into the state transition diagram according to the acquired restrictive condition, to validate through the model checking whether the acquired state transition diagram satisfies the request, to output the validation result of the request, to convert the acquired coverage metrics into the temporal logic, to measure the coverage in the state transition diagram through the model checking, according to the converted temporal logic, and to output the measurement result of the coverage.

An operation of the validation processing apparatus 300 thus constructed according to this embodiment will now be described in details. As shown in FIG. 1, the operation of the validation processing apparatus 300 can be broadly classified in two jobs, which are validating the property upon applying the property validation unit 305 to the data acquired by the property acquisition unit 301, the design acquisition unit 302, and the constraint acquisition unit 303, and measuring the coverage upon applying the coverage measurement unit 306 to the data acquired by the design acquisition unit 302, the constraint acquisition unit 303, and the index acquisition unit 304.

Firstly, the property validating operation, to which the property validation unit 305 is applied, will be described. The design data of the data processing system acquired by the design acquisition unit 302 is converted into the Sequential circuit, by the circuit conversion unit 308.

The conversion of the data processing system into the Sequential circuit is executed as follows, for example. In the case where the design acquisition unit 302 has acquired design data of a clock synchronous logic circuit, the design data is a Sequential circuit.

In the case where design data of a non-clock synchronous logic circuit has been acquired, internal states of the circuits that may arise are listed, so as to convert the data into a Sequential circuit through assumption of a sequential machine that expresses changes of the states.

In the case where the computer program is acquired as the design data by the design acquisition unit 302, and if the program is described in the C language for example, the program can be converted into a Sequential circuit by treating one row as one state and through assumption of a sequential machine that expresses the state transition.

Then, the Kripke structure conversion unit 309 converts the Sequential circuit converted by the circuit conversion unit 308 and the restrictive condition acquired by the constraint acquisition unit 303 into the state transition diagram for the model checking, which is called as Kripke structure.

The conversion into the state transition diagram having the Kripke structure is executed by a known method, for example the one described in the non-patented document 1. The conversion is executed so as to reflect the restrictive condition acquired by the constraint acquisition unit 303, which is practically achieved, for example as described in the non-patented document 1, by obtaining the conjunction of the transition relation function and the logical formula representing the restrictive condition acquired by the constraint acquisition unit 303.

For example, in the case where the restrictive condition acquired by the constraint 303 is “a AND b are always 0”, the conjunction of the transition relation function obtained according to the non-patented document 1 and the logical formula of (a AND b=0) is calculated.

Thereafter, the model checking unit 310 validates through the model checking whether the state transition diagram having the Kripke structure thus converted satisfies the property acquired by the property acquisition unit 301.

The model checking may be executed, for example, by a known algorithm stated in the non-patented document 1. The validation output unit 307 outputs the result of the validation based on the model checking, executed by the model checking unit 310, to a display unit or a disk drive unit.

For example, if a state or a transition path contradictory to the property acquired by the property acquisition unit 301 is detected, the validation output unit 307 outputs to the effect of “property violated”. When a state or a transition path indicating that the property acquired by the property acquisition unit 301 is established is detected, the validation output unit 307 outputs to the effect of “property satisfied”. Such arrangement allows the user to check whether the property designated by the data processing system, which is the object to be validated, is satisfied.

The operation in which the coverage measurement unit 306 is involved will now be described in details. The design data of the data processing system acquired by the design acquisition unit 302 is converted into the Sequential circuit by the circuit conversion unit 311. The circuit conversion unit 311 works similarly to the circuit conversion unit 308.

Then the Kripke structure conversion unit 312 converts the Sequential circuit converted by the circuit conversion unit 311 and the restrictive condition acquired by the constraint acquisition unit 303 into the state transition diagram having the Kripke structure.

The Kripke structure conversion unit 312 works similarly to the Kripke structure conversion unit 309. The logic conversion unit 313 the converts the coverage metrics acquired by the index acquisition unit 304 into a temporal logic such as CTL or LTL.

For example, an index as “whether an event that a variable present in the description of the data processing system becomes equal to a predetermined value is included” is converted into a temporal logic that “a variable present in the description of the data processing system may take a predetermined value”.

More specifically, on the assumption that a variable A is present in the description of the data processing system, the index as “whether an event that A becomes five is included in the validation range” is converted into the temporal logic to the effect that A may become five somewhere in future. This may be expressed as “EF(A=5)” in CTL temporal logical formula.

Another example is given hereunder. In the case where such an index as “whether an event that a logical formula including a variable present in the description of the data processing system is established is included” is given, the index is converted into a temporal logic to the effect that “such logical formula may be established in future”.

For example, on the assumption that variables A, B, and C are present in the description of the data processing system, an index as “whether an event that A +B=C is established is included in the validation range” is converted into a temporal logic to the effect that “(A+B=C). may be established in future”. This may be expressed as “EF (A+B=C)” in CTL temporal logical formula.

As another example, in the case where such an index as “whether an event that the truth or falsehood of a logical formula including a variable present in the description of the data processing system indicates a predetermined permutation or a temporal change is included” is given, the index is converted into a temporal logic to the effect that “the truth or falsehood of that logical formula may indicate a predetermined permutation or a temporal change, somewhere in future”.

More specifically, on the assumption that variables A, B, and C are present in the description of the data processing system, an index as “whether an event that B=C is established after A=1 is established is included in the validation range” is converted into a temporal logic to the effect that “B=C may be established after A=1 is established, somewhere in future”. This may be expressed as “EF(A=1&EF(B=C))” in CTL temporal logical formula.

As another example, in the case where such an index as “whether an event originating from a row in the description of the data processing system is included” is given, the index is converted into a temporal logic to the effect that “the condition that allows the event originating that row may become true in future”.

For example, in the case where an index as “whether an event originating from the tenth row of the description of the data processing system is included” is given, the validation processing apparatus operates as follows. The circuit conversion unit 311 records information as to which event of the Sequential circuit the tenth row corresponds to, during the process of converting the description of the data processing system into the Sequential circuit.

If the condition that allows emergence of the event in the Sequential circuit corresponding to the tenth row is “A=1”, the index is converted into a temporal logic to the effect that “A=1 may be established in future”. This may be expressed as “EF(A=1)” in CTL temporal logical formula.

Thereafter, the model checking unit 314 measures through the model checking the coverage in the state transition diagram having the Kripke structure converted by the Kripke structure conversion unit 312, according to the temporal logic, i.e. the property acquired by the logic conversion unit 313.

The model checking may be executed, for example, based on the algorithm stated in the non-patented document 1. The measurement output unit 315 outputs the coverage measured by the model checking unit 314 through the model checking, to a display unit or a disk drive unit.

For example, in the case where a temporal logic converted by the logic conversion unit 313 from a coverage metrics A acquired by the index acquisition unit 304 is established, the measurement output unit 315 outputs to the effect that “the coverage metrics index A has been covered”.

In contrast, in the case where a temporal logic converted by the logic conversion unit 313 from a coverage metrics acquired by the index acquisition unit 304 is not established, the measurement output unit 315 outputs to the effect that “the coverage metrics B cannot be covered”. Such arrangement allows the user to check whether the coverage designated by the data processing system, being the object to be validated, is satisfied.

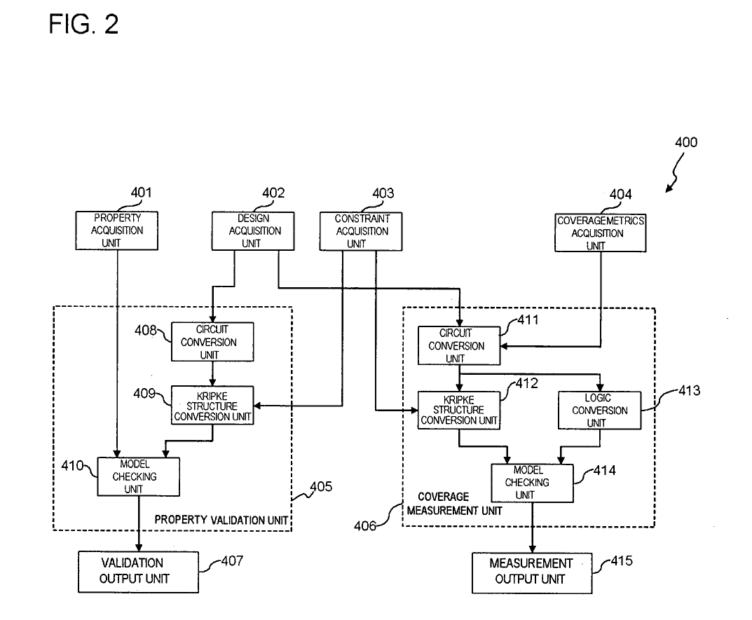

Referring now to FIG. 2, a second embodiment of the present invention will be described in details. The validation processing apparatus 400 according to this embodiment includes units 401 to 415 logically configured, as in the foregoing validation processing apparatus 300.

The validation processing apparatus 400 is, however, different from the validation processing apparatus 300 in the configuration of the coverage measurement unit 406. Specifically, the circuit conversion unit 411 acquires a coverage metrics acquired by the index acquisition(input) unit 404, and the logic conversion unit 413 acquires a result output by the circuit conversion unit 411.

The circuit conversion unit 411 converts the coverage metrics acquired by the index acquisition unit 404 into a Sequential circuit, in addition to converting the data of the data processing system acquired by the design acquisition(input) unit 402, as does the circuit conversion unit 311.

The logic conversion unit 413 converts the coverage metrics into a property based on the conversion result of the coverage metrics acquired by the index acquisition unit 404 into the Sequential circuit by the circuit conversion unit 411.

To be more detailed, the circuit conversion unit 411 converts the data processing system and the coverage metrics into such Sequential circuit that has the function of performing a predetermined event in the case where an event of the data processing system, which is the object to be validated, accords with the coverage metrics. The “predetermined event” may be such an event that a signal value becomes a certain predetermined value.

The logic conversion unit 413 generates a property representing the predetermined event that takes place when the event that fulfills the coverage metrics arises, with respect to the Sequential circuit converted as above. In other words, the logic conversion unit 413 generates a circuit that detects an event that fulfills the coverage metrics index, and generates the property with respect to such circuit.

For example, on the assumption that a variable A is present in the description of the data processing system, in the case where an index as “whether an event that A becomes five is included in the validation range” is acquired, the circuit conversion unit 411 generates a circuit where a signal S becomes 1 when A=5 is established but the signal S becomes 0 when A=5 is not established. Then the logic conversion unit 413 generates a temporal logic to the effect that “S=1 may be established in future”.

Another example is given on the assumption that variables A, B, and C are present in the description of the data processing system. In the case where an index as “whether an event that A+B=C is established is included in the validation range” is acquired, the circuit conversion unit 411 generates a circuit where the signal S becomes 1 when A+B=C is established but the signal S becomes 0 when A+B=C is not established. Then the logic conversion unit 413 generates a temporal logic to the effect that “S=1 may be established in future”.

Still another example is given on the assumption that variables A, B, and C are present in the description of the data processing system. In the case where an index as “whether an event that B=C is established in the next cycle after A=1 is established is included in the validation range” is acquired, the circuit conversion unit 411 generates a circuit where the signal S becomes 1 only when B=C is established in the next cycle after A=1 is established. Then the logic conversion unit 413 generates a temporal logic to the effect that “S=1 may be established in future”.

It is to be understood that the present invention is not limited to the foregoing embodiments, but may be modified in various manners without departing from the spirit and scope of the present invention. It is apparent that the present invention is not limited to the above embodiment, and may be modified and changed without departing from the scope and spirit of the invention.

What is claimed is:

1. A validation processing apparatus comprising:
a graph acquisition unit that acquires a state transition graph of a data processing system being an object to be validated;
a property acquisition unit that acquires a request to said data processing system;
an index acquisition unit that acquires a coverage metrics indicating events to be included in a validation range of said data processing system;
a property validation unit that validates whether said acquired state transition graph satisfies said request;
a validation output unit that outputs a validation result of said request;
a coverage measurement unit that measures said coverage in said state transition graph according to said acquired coverage metrics; and
a measurement output unit that outputs a measurement result of said coverage.

2. The validation processing apparatus according to claim 1, further comprising:
a logic conversion unit that converts said acquired coverage metrics into a temporal logic;
wherein said coverage measurement unit measures a coverage in said state transition graph according to said converted temporal logic.

3. The validation processing apparatus according to claim 1, further comprising:
a design acquisition unit that acquires design data describing at least one of a function and a specification of said data processing system being the object to be validated;
a constraint acquisition unit that acquires a restrictive condition that delimits a validation range in said events of said data processing system;
a circuit conversion unit that converts said acquired design data and said coverage metrics into a Sequential circuit respectively; and checking
a structure conversion unit that converts said Sequential circuit converted from said design data into said state transition graph according to said restrictive condition.

4. The validation processing apparatus according to claim 2, further comprising:
a design acquisition unit that acquires design data describing at least one of a function and a specification of said data processing system being the object to be validated;
a constraint acquisition unit that acquires a restrictive condition that delimits a validation range in said events of said data processing system;
a circuit conversion unit that converts said acquired design data and said coverage metrics into a Sequential circuit respectively; and
a structure conversion unit that converts said Sequential circuit converted from said design data into said state transition graph according to said restrictive condition.

5. The validation processing apparatus according to claim 3, further comprising:
a logic conversion unit that generates a temporal logic from said Sequential circuit converted from said coverage metrics.

6. The validation processing apparatus according to claim 4, further comprising:
a logic conversion unit that generates a temporal logic from said Sequential circuit converted from said coverage metrics.

7. The validation processing apparatus according to claim 1, further comprising:
a constraint acquisition unit that acquires a restrictive condition that delimits a validation range in events of said data processing system;
a circuit acquisition unit that acquires a Sequential circuit of said data processing system; and
a structure conversion unit that converts said Sequential circuit into said state transition graph according to said acquired restrictive condition.

8. The validation processing apparatus according to claim 2, further comprising:
a constraint acquisition unit that acquires a restrictive condition that delimits a validation range in events of said data processing system;
a circuit acquisition unit that acquires a Sequential circuit of said data processing system; and
a structure conversion unit that converts said Sequential circuit into said state transition graph according to said acquired restrictive condition.

9. The validation processing apparatus according to claim 7, further comprising:
a design acquisition unit that acquires design data describing at least one of a function and a specification of said data processing system being the object to be validated; and
a circuit conversion unit that converts said acquired design data into said Sequential circuit.

10. The validation processing apparatus according to claim 8, further comprising:
a design acquisition unit that acquires design data describing at least one of a function and a specification of said data processing system being the object to be validated; and
a circuit conversion unit that converts said acquired design data into said Sequential circuit.

11. The validation processing apparatus according to claim 3,
wherein said structure conversion unit converts said Sequential circuit into said state transition graph having a Kripke structure, according to said acquired restrictive condition.

12. The validation processing apparatus according to claim 5,
wherein said structure conversion unit converts said Sequential circuit into said state transition graph having a Kripke structure, according to said acquired restrictive condition.

13. The validation processing apparatus according to claim 7,
wherein said structure conversion unit converts said Sequential circuit into said state transition graph having a Kripke structure, according to said acquired restrictive condition.

14. The validation processing apparatus according to claim 9,
wherein said structure conversion unit converts said Sequential circuit into said state transition graph having a Kripke structure, according to said acquired restrictive condition.

15. The validation processing apparatus according to claim 1,
wherein said property validation unit includes a model checking unit that validates said request through a model checking method.

16. The validation processing apparatus according to claim 2,
wherein said property validation unit includes a model checking unit that validates said request through a model checking method.

17. The validation processing apparatus according to claim 1,
wherein said coverage measurement unit includes a model checking unit that measures said coverage through a model checking method.

18. The validation processing apparatus according to claim 2,
wherein said coverage measurement unit includes a model checking unit that measures said coverage through a model checking method.

19. A computer program to be implemented in said validation processing apparatus according to claim 1, comprising causing said validation processing apparatus to:
acquire a state transition graph of a data processing system being an object to be validated;
acquire a request to said data processing system;
acquire a coverage metrics indicating events to be included in a validation range of said data processing system;
validate whether said acquired state transition graph satisfies said request;
measure said coverage in said state transition graph according to said acquired coverage metrics; and
output validation result of said request and a measurement result of said coverage.
